(19) United States
(12) Patent Application Publication
(10) Pub. No.: US 2023/0040695 A1
(43) Pub. Date: Feb. 9, 2023

(54) METHOD AND APPARATUS FOR DELETING TRAINED DATA OF DEEP LEARNING MODEL

(71) Applicant: RESEARCH & BUSINESS FOUNDATION SUNGKYUNKWAN UNIVERSITY, Suwon-si (KR)

(72) Inventors: Jun Yaup KIM, Gwangju (KR); Min Ha KIM, Suwon-si (KR); Simon Sungil WOO, Suwon-si (KR)

(73) Assignee: RESEARCH & BUSINESS FOUNDATION SUNGKYUNKWAN UNIVERSITY, Suwon-si (KR)

(21) Appl. No.: 17/881,753

(22) Filed: Aug. 5, 2022

(30) Foreign Application Priority Data
Aug. 5, 2021 (KR) 10-2021-0102997

(51) Int. Cl. G06N 3/08; G06N 3/04

(52) U.S. Cl. CPC G06N 3/08; G06N 3/0454

(57) ABSTRACT

The present disclosure relates to a method and an apparatus for deleting training data of a deep learning model. The trained data deleting method according to an exemplary embodiment of the present disclosure includes calculating a result value for a label allocated to data to be deleted which is included in the training data; reallocating a label of the data to be deleted by comparing the result value; generating a neutralized model obtained by neutralizing the deep learning model with the data to be deleted and a reallocated label of the data to be deleted as inputs; and training the neutral model based on retrained data which is training data, excluding the data to be deleted, among the trained data.

### BACKGROUND

### Field

The present disclosure relates to a method and an apparatus for deleting and unlearning user-requested trained data of a deep learning model.

### Description of the Related Art

A deep learning model is a specific field of machine learning and is a new type of model to learn an expression from data. In order to train the deep learning model, a large amount of learning data is essential and there may be a situation in which previously trained data needs to be deleted from the deep learning model due to the copyright, privacy, or GDPR's “the right to be forgotten” issue.

Accordingly, in the related art, in order to suppress such problems, learning data before training is divided into the predetermined number and the training process of the deep learning model is carried out as many as the divided number.

However, according to this method, the number of deep learning models is increased to occupy a lot of memories and it is inefficient because in order to delete specific data in a training set, a training and evaluation pipeline of the entire deep learning process needs to be repeated.

Accordingly, when a deletion request issue of trained data occurs, a necessity for a method for efficiently deleting specific trained data which is requested to be deleted without changing a pipeline of the entire deep learning model is demanded.

### SUMMARY

An object of the present disclosure is to provide a method and an apparatus for deleting trained data which generate a neutralized model using a label of reallocated data to be deleted by reducing an accuracy of data to be deleted and efficiently delete the data to be removed.

Further, an object of the present disclosure is to provide a method and an apparatus for deleting trained data which improve an accuracy of a neutralized model from which data to be deleted is removed using retrained data.

The object of the present disclosure is not limited to the above-mentioned objects and other objects and advantages of the present disclosure which have not been mentioned above may be understood by the following description and become more apparent from exemplary embodiments of the present disclosure. Further, it may be understood that the objects and advantages of the present disclosure may be embodied by the means and a combination thereof in the claims.

According to an aspect of the present disclosure, a trained data deleting method includes calculating a result value for a label allocated to data to be deleted which is included in the trained data; reallocating a label of the data to be deleted by comparing the result value; generating a neutralized model obtained by neutralizing the deep learning model with the data to be deleted and a reallocated label of the data to be deleted as inputs; and training the neutralized model based on retrained data which is training data, excluding the data to be deleted, among the training data set.

Further, in an exemplary embodiment of the present disclosure, the calculating of result values further includes averaging the result values according to the number of data to be deleted.

Further, in an exemplary embodiment of the present disclosure, the reallocation includes: identifying an object label having a lowest result value, among calculated result values of the labels; and reallocating the object label as a label of the data to be deleted when the object label is not the same as a previously allocated label of the data to be deleted.

In an exemplary embodiment of the present disclosure, the generating of a neutralized model includes: training the deep learning model using the data to be deleted and a label to which the data to be deleted is reallocated; calculating an accuracy for the data to be deleted; and stopping the learning and generating a neutralized model when the accuracy is equal to or lower than a predetermined threshold value.

In an exemplary embodiment of the present disclosure, the threshold value is a reciprocal number of the number of labels allocated to the data to be deleted.

In an exemplary embodiment of the present disclosure, the training process includes: training the neutral model using a knowledge distillation technique in which the deep learning model serves as a teacher and the neutralized model serves as a student.

According to another aspect of the present disclosure, a trained data deleting apparatus includes a calculation unit which calculates a result value for a label allocated to data to be deleted which is included in the trained data; a reallocation unit which reallocates a label of the data to be deleted by comparing the result value; a model output unit which generates a neutral model obtained by neutralizing the deep learning model with the data to be deleted and a reallocated label of the data to be deleted as inputs; and a retraining unit which trains the neutral model based on retrained data which is trained data, excluding the data to be deleted, among the training data.

In an exemplary embodiment of the present disclosure, the calculating unit averages the result values according to the number of data to be deleted.

In an exemplary embodiment of the present disclosure, the reallocation unit identifies an object label having a lowest result value, among calculated result values of the labels and reallocates the object label as a label of the data to be deleted when the object label is not the same as a previously allocated label of the data to be deleted.

In an exemplary embodiment of the present disclosure, the model generation unit 130 trains the deep learning model using the data to be deleted and the label to which the data to be deleted is reallocated and calculates an accuracy for the data to be deleted to stop the learning when the accuracy is equal to or lower than a predetermined threshold value and generate a neutral model.

In an exemplary embodiment of the present disclosure, the threshold value is a reciprocal number of the number of labels allocated to the data to be deleted.

In an exemplary embodiment of the present disclosure, the retraining unit trains the neutral model using a knowledge distillation technique in which the deep learning model serves as a teacher and the neutral model serves as a student.

According to the method and apparatus for deleting trained data according to an exemplary embodiment of the present disclosure, a neutral model is generated using a label of reallocated data to be deleted to reduce an accuracy of the data to be deleted and efficiently delete the data to be removed.

According to the method and apparatus for deleting specific training data according to an exemplary embodiment of the present disclosure, an accuracy of a neutral model from which data to be deleted is removed may be improved using retrained data.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a diagram of a training data deleting apparatus according to an exemplary embodiment of the present disclosure;

FIG. 2 is a detailed diagram of a trained data deleting apparatus according to an exemplary embodiment of the present disclosure;

FIG. 3 is a view illustrating data to be deleted and a dataset in an exemplary embodiment of the present disclosure;

FIG. 4 is a view illustrating a process of reallocating a label of data to be deleted in an exemplary embodiment of the present disclosure; and

FIG. 5 is a flowchart of a training data deleting method according to an exemplary embodiment of the present disclosure.

### DETAILED DESCRIPTION OF THE EMBODIMENT

Those skilled in the art may make various modifications to the present disclosure and the present disclosure may have various embodiments thereof, and thus specific embodiments will be illustrated in the drawings and described in detail in detailed description. However, this does not limit the present disclosure within specific exemplary embodiments, and it should be understood that the present disclosure covers all the modifications, equivalents and replacements within the spirit and technical scope of the present disclosure. In the description of respective drawings, similar reference numerals designate similar elements.

Terms such as first, second, A, or B may be used to describe various components but the components are not limited by the above terms. The above terms are used only to distinguish one component from the other component. For example, without departing from the scope of the present disclosure, a first component may be referred to as a second component, and similarly, a second component may be referred to as a first component. A term of and/or includes combination of a plurality of related elements or any one of the plurality of related elements.

It should be understood that, when it is described that an element is “coupled” or “connected” to another element, the element may be directly coupled or directly connected to the other element or coupled or connected to the other element through a third element. In contrast, when it is described that an element is “directly coupled” or “directly connected” to another element, it should be understood that no element is not present therebetween.

Terms used in the present application are used only to describe a specific exemplary embodiment, but are not intended to limit the present invention. A singular form may include a plural form if there is no clearly opposite meaning in the context. In the present disclosure, it should be understood that terminology “include” or “have” indicates that a feature, a number, a step, an operation, a component, a part or the combination thereof described in the specification is present, but do not exclude a possibility of presence or addition of one or more other features, numbers, steps, operations, components, parts or combinations, in advance.

If it is not contrarily defined, all terms used herein including technological or scientific terms have the same meaning as those generally understood by a person with ordinary skill in the art. Terms defined in generally used dictionary shall be construed that they have meanings matching those in the context of a related art, and shall not be construed in ideal or excessively formal meanings unless they are clearly defined in the present application.

Hereinafter, an exemplary embodiment of the present invention will be described in detail with reference to the accompanying drawings.

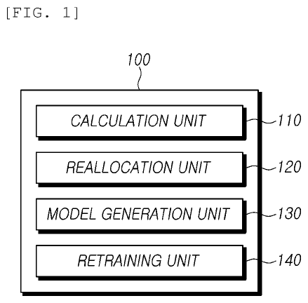

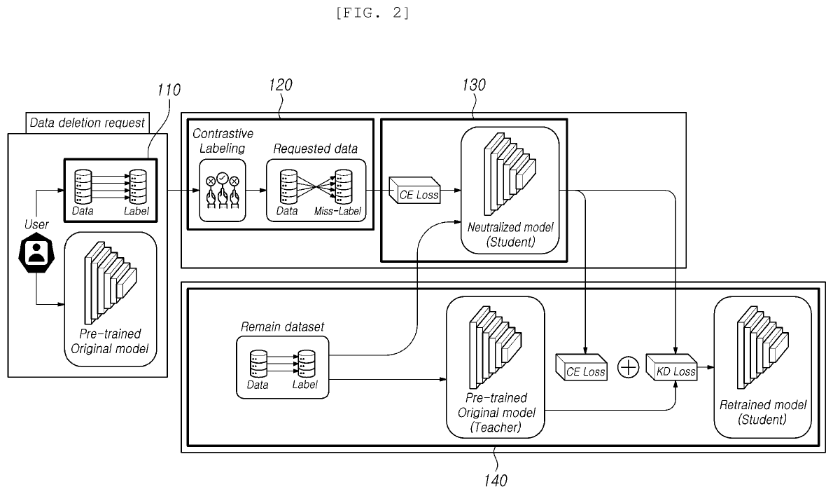

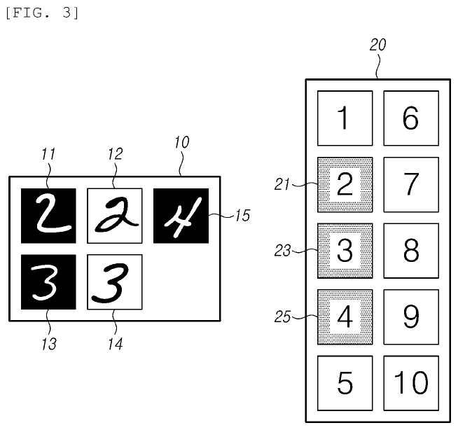

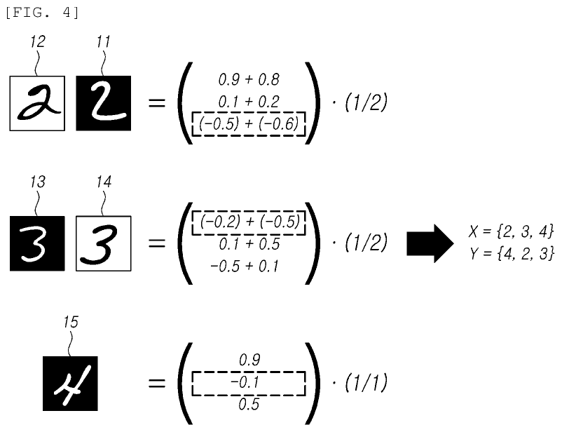

FIG. 1 is a diagram of a training data deleting apparatus according to an exemplary embodiment of the present disclosure. FIG. 2 is a detailed diagram of a training data deleting apparatus according to an exemplary embodiment of the present disclosure. FIG. 3 is a view illustrating data to be deleted and a data set in an exemplary embodiment of the present disclosure. FIG. 4 is a view illustrating a process of reallocating a label of data to be deleted in an exemplary embodiment of the present disclosure. Hereinafter, a trained data deleting apparatus will be described with reference to FIGS. 1 to 4.

Referring to FIGS. 1 and 2, a training data deleting apparatus 100 is an apparatus which deletes some training data among the entire training data used for a deep learning model and includes a calculation unit 110, a reallocation unit 120, a model generation unit 130, and a retraining unit 140. Here, the training data which will be deleted is data to be deleted and refers to training data which is a deleting target according to a request of a person who has a right for the training data.

The calculation unit 110 calculates a result value for a label allocated to the data to be deleted, by means of a previously trained deep learning model, with respect to the data to be deleted included in the training data.

At this time, the previously trained deep learning model may be a convolution neural network (CNN) model which is an image classification model and a result value may be a probability value of the training data derived by means of the CNN model. Further, there may be a plurality of data to be deleted.

Further, each training data has a label allocated by the deep learning model. For example, when there are labels 1 to 10, 1 to 10 of different labels may be allocated to trained data according to the deep learning result.

Referring to FIG. 3, when data 10 to be deleted is configured by five training data 11, 12, 13, 14, 15, each of five trained data matches any one of 10 labels of the dataset 20. For example, training data 11 and 12 may be allocated to a label 21, training data 13 and 14 may be allocated to a label 23, and training data 15 may be allocated to a label 25, respectively.

The calculation unit 110 calculates a result value for a label allocated to the data to be delated by means of the deep learning model, with respect to each data 10 to be deleted. That is, the calculation unit 110 calculates a result value of the data 10 to be deleted only for the labels 21, 22, and 23 which are allocated to the data 10 to be deleted.

The result value is a value obtained by representing a probability that specific data to be deleted corresponds to a specific label as a numerical value and for example, the training data 11 and 12 may have a high result value for the label 21 and may have a low result value for the label 23 or the label 25.

In the meantime, according to the exemplary embodiment of the present disclosure, the calculation unit 110 may calculate an average of the calculated result values according to the number of data to be deleted allocated to the same label.

That is, the calculated result values are accumulated so that the result value may vary depending on the number of data to be deleted. Accordingly, the result values accumulated for the same label may be divided by the number of data to be deleted to calculate an average.

Referring to FIG. 4, when training data 11 has a result value of 0.9 for the label 21 and training data 12 has a result value of 0.8 for the label 21, the final result value is 0.85 obtained by dividing 1.7 by 2, which is the number of data to be deleted, rather than 1.7.

Similarly, when training data 11 has a result value of 0.1 for the label 23 and training data 12 has a result value of 0.2 for the label 23, the final result value is 0.15 obtained by dividing 0.3 by 2, which is the number of data to be deleted, rather than 0.3.

In contrast, training data 15 has one data to be deleted, each of the labels 21, 23, and 25 may have final result values 0.9, −0.1, and 0.5, respectively, without the averaging process.

As described above, the calculation unit 110 performs a process of calculating an average of the calculated result values so that distortion of the result values depending on the number of data to be deleted may be prevented.

The reallocation unit 120 compares the calculated result values to reallocate a label of the data to be deleted.

That is, the reallocation unit 120 identifies an object label having the lowest result value among result values of the labels calculated using the contrastive learning and reallocates the object label as a label of the data to be deleted.

Referring to FIG. 4 again, an object label for training data 11 and training data 12 is a label 25 having the lowest result value, among result values 0.85, 0.15, −0.55 which are result values of the labels 21, 23, and 25, respectively.

Similarly, an object label for training data 13 and training data 14 is a label 21 and an object label of training data 15 is a label 23.

That is, in the dataset X of the related art, training data 11 and 12 are allocated to a label 21 and training data 13 and 14 are allocated to a label 22, and training data 15 is allocated to a label 25 (X={2, 3, 4}), but the reallocation unit 120 generates a new dataset Y by reallocating the training data 11 and 12 to the label 25, the training data 13 and 14 to the label 21, and the training data 15 to the label 23 (Y={4, 2, 3}).

In the meantime, according to the exemplary embodiment of the present disclosure, as the allocation result, when a reallocated label is the same as a previously allocated label, the reallocation unit 120 may substitute the result value of the corresponding label with infinite.

If the reallocated label is the same as the previously allocated label, when the data to be deleted is reallocated to the corresponding label, the data to be deleted is not deleted in the deep learning model.

Accordingly, the reallocation unit 120 substitutes the result value of the object label which is the same as the previously allocated label with the infinite to prevent the object label which is the same as the previously allocated label from being reallocated as the label of the data to be deleted.

Further, in the exemplary embodiment of the present disclosure, there may be only one previously allocated label. In this case, there is no label to which data to be deleted is reallocated, other than the previously allocated label, so that the calculation unit 110 calculates a result value not only for the label allocated to the data to be deleted, but also for all the labels included in the dataset 20 and the reallocation unit 120 sets a label having the lowest result value among the result values of all the labels as an object label to reallocate the label as a label of the data to be deleted.

The model generation unit 130 generates a neutral model obtained by neutralizing the deep learning model using data to be deleted and a label to which the data to be deleted is reallocated.

That is, the model generation unit 130 trains the deep learning model using the data to be deleted and the label to which the data to be deleted is reallocated and calculates an accuracy for the data to be deleted to stop the learning when the accuracy is equal to or lower than a predetermined threshold value and generate a neutral model.

Here, the accuracy is a probability that input data to be deleted is mapped to the previously allocated label and the lower the accuracy, the more the data to be deleted is deleted from the deep learning model.

Further, the neutralized model is a model in which the data to be deleted is removed from the deep learning model. The model generation unit 130 generates the neutralized model by training the deep learning model until the accuracy becomes a threshold value or lower with a reallocated label of the data to be deleted as an input.

At this time, the threshold value may be a reciprocal number of the number of labels allocated to the data to be deleted. That is, as illustrated in FIG. 3, when the number of labels is 3 (labels 21, 23, and 25), the threshold value may be ⅓ which is a reciprocal number of 3. In other words, when the accuracy is approximately 33% or lower, the model generation unit 130 determines that the data to be deleted has been deleted and generates the neutral model. As described above, the threshold value may be flexibly changed according to the number of labels allocated to the data to be deleted.

In contrast, according to an exemplary embodiment, the threshold value may be 0. At this time, the accuracy which is equal to or lower than the threshold value is only 0 so that when the accuracy is 0, it means that the data to be deleted is completely removed from the deep learning model. Accordingly, when it is necessary to strictly determine whether the data to be deleted is deleted, the model generation unit 130 sets the threshold value as 0 to completely remove the data to be deleted from the deep learning model.

The retraining unit 140 trains the neutral model based on retrained data which is training data, excluding the data to be deleted, among training data.

Specifically, the retraining unit 140 trains the neutral model using a knowledge distillation technique in which the deep learning model serves as a teacher and the neutral model serves as a student. The knowledge distillation technique is a known technique so that a detailed description thereof will be omitted.

As described above, the retraining unit 140 trains the neutral model based on the retrained data to quickly improve the accuracy of the neutralized model in which the data to be deleted is removed.

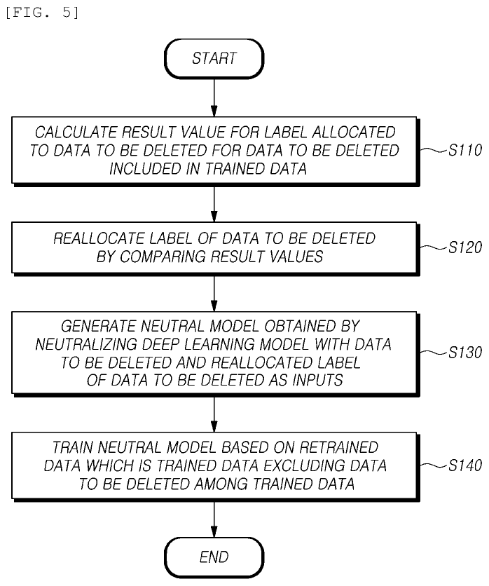

FIG. 5 is a flowchart of a trained data deleting method according to an exemplary embodiment of the present disclosure. Referring to the drawing, the training data deleting method is a method for deleting training data used for a deep learning model using a training data deleting apparatus 100 and calculates a result value for a label allocated to data to be deleted which is included in the trained data (S110).

Further, the training data deleting apparatus 100 compares a result value to reallocate a label of the data to be deleted (S120). Specifically, the training data deleting apparatus 100 identifies an object label having a lowest result value, among calculated result values of the labels and reallocates the object label as a label of the data to be deleted when the object label is not the same as the previously allocated label of the data to be deleted.

Thereafter, the training data deleting apparatus 100 generates a neutralized model obtained by neutralizing the deep learning model with data to be deleted and a reallocated label of the data to be deleted as inputs (S130). Specifically, the training data deleting apparatus 100 trains the deep learning model using the data to be deleted and the label to which the data to be deleted is reallocated, calculates an accuracy for the data to be deleted, and stops the learning when the accuracy is equal to or lower than a predetermined threshold value and generates a neutral model.

Finally, the trained data deleting apparatus 100 trains the neutral model based on retrained data which is trained data, excluding the data to be deleted, among trained data (S140).

As described above, the method and apparatus for deleting training data according to the exemplary embodiment of the present disclosure generate a neutral model using data to be deleted and a reallocated label of the data to be deleted to reduce an accuracy of the data to be deleted and efficiently delete the data to be deleted.

Further, the method and apparatus for deleting training data according to the exemplary embodiment of the present disclosure may improve an accuracy of a neutral model from which data to be deleted is removed using retrained data.

As described above, although the present disclosure has been described with reference to the exemplary drawings, it is obvious that the present disclosure is not limited by the exemplary embodiment and the drawings disclosed in the present disclosure and various modifications may be performed by those skilled in the art within the range of the technical spirit of the present disclosure. Further, although the effects of the configuration of the present disclosure have not been explicitly described while describing the embodiments of the present disclosure, it is natural that the effects predictable by the configuration should also be recognized.

What is claimed is:

1. A method for deleting training data used for a deep learning model, the method comprising:
calculating a result value for a label allocated to data to be deleted which is included in the trained data;
reallocating a label of the data to be deleted by comparing the result value;
generating a neutral model obtained by neutralizing the deep learning model with the data to be deleted and a reallocated label of the data to be deleted as inputs; and
training the neutral model based on retrained data which is training data, excluding the data to be deleted, among the trained data.

2. The training data deleting method according to claim 1, wherein the calculating of a result value includes:
averaging the result values according to the number of data to be deleted.

3. The training data deleting method according to claim 1, wherein the reallocating includes:
identifying an object label having a lowest result value, among calculated result values of the labels; and
reallocating the object label as a label of the data to be deleted when the object label is not the same as a previously allocated label of the data to be deleted.

4. The training data deleting method according to claim 1, wherein the generating of a neutral model includes:
training the deep learning model using the data to be deleted and a label to which the data to be deleted is reallocated;
calculating an accuracy for the data to be deleted; and
stopping the learning and generating a neutral model when the accuracy is equal to or lower than a predetermined threshold value.

5. The training data deleting method according to claim 4, wherein the threshold value is a reciprocal number of the number of labels allocated to the data to be deleted.

6. The training data deleting method according to claim 1, wherein the training includes:
training the neutralized model using a knowledge distillation technique in which the deep learning model serves as a teacher and the neutral model serves as a student.

7. An apparatus for deleting training data used for a deep learning model, the apparatus comprising:
a calculation unit which calculates a result value for a label allocated to data to be deleted which is included in the trained data;
a reallocation unit which reallocates a label of the data to be deleted by comparing the result value;
a model output unit which generates a neutral model obtained by neutralizing the deep learning model with the data to be deleted and a reallocated label of the data to be deleted as inputs; and
a retraining unit which trains the neutral model based on retrained data which is trained data, excluding the data to be deleted, among the trained data.

8. The training data deleting apparatus according to claim 7, wherein the calculation unit averages the result values according to the number of data to be deleted.

9. The training data deleting apparatus according to claim 7, wherein the reallocation unit identifies an object label having a lowest result value, among calculated result values of the labels and reallocates the object label as a label of the data to be deleted when the object label is not the same as a previously allocated label of the data to be deleted.

10. The training data deleting apparatus according to claim 7, wherein the model generation unit trains the deep learning model using the data to be deleted and a label to which the data to be deleted is reallocated and calculates an accuracy for the data to be deleted and when the accuracy is equal to or lower than a predetermined threshold value, stops the learning and generates a neutralized model.

11. The training data deleting apparatus according to claim 10, wherein the threshold value is a reciprocal number of the number of labels allocated to the data to be deleted.

12. The training data deleting apparatus according to claim 7, wherein the retraining unit trains the neutralized model using a knowledge distillation technique in which the deep learning model serves as a teacher and the neutral model serves as a student.
